(19) United States
(12) Patent Application Publication
(10) Pub. No.: US 2026/0237249 A1
(43) Pub. Date: Aug. 13, 2026

(54) METHOD FOR DETERMINING AT LEAST ONE STATUS OF A VEHICLE, AND AN INFORMATION TECHNOLOGY SYSTEM

(71) Applicant: MERCEDES-BENZ GROUP AG, Stuttgart (DE)

(72) Inventors: Jörg ECHARD, Sindelfingen (DE); Martin KEPPLER, Oberreichenbach (DE)

(21) Appl. No.: 19/155,723

(22) PCT Filed: Jan. 22, 2024
(86) PCT No.: PCT/EP2024/051456

§ 371 Date: Aug. 12, 2025

(30) Foreign Application Priority Data
Feb. 13, 2023 (DE) 10 2023 000 462.6

(51) Int. Cl. G07C 5/00; H04W 4/44

(52) U.S. Cl. CPC G07C 5/008; H04W 4/44

(57) ABSTRACT

A vehicle determines at least one status of the vehicle and transmits this to a vehicle-external central computer using a vehicle-internal telecommunications unit when there is an existing wireless communication link and transmits the status to a mobile end device communicatively coupled to the vehicle when the existing wireless communication link is interrupted. The mobile end device temporarily caches the status received from the vehicle and passes it on to the central computing unit when a wireless communication link is available between the mobile end device and the central computing unit. The vehicle only determines the status in the case of interrupted communication link to the central computing unit when the doors of the vehicle are locked and then transmits the status to the mobile end device.

### BACKGROUND AND SUMMARY OF THE INVENTION

Exemplary embodiments of the invention relate to a method for determining at least one status of a vehicle, as well as to an information technology system.

Digitalization also advances in the automotive industry. Increasingly, vehicles are networked, which enables the provision of novel security and convenience functions. Vehicles can detect, monitor, and document the status of a vehicle subsystem or vehicle components and provide it as information. For this purpose, data is read out by control devices of the vehicle. For example, a status can be requested about whether the window of the vehicle is open or closed, the tank capacity of the tank of the vehicle or the charging state of the traction battery of the vehicle, whether the doors of the vehicle are locked, and similar.

This status information can be transmitted from the vehicle to a central point, for example a server operated by the vehicle manufacturer. Then read or write access to the server can take place via the internet. Thus, not only can the status be requested, but control commands can also be given, such as closing the window or switching off the parking lights remotely. Typically, a telecommunications unit is provided in the vehicle for a data connection of the vehicle to the server, which enables access to the internet and thus to the server via mobile radio.

Suitable software, also referred to as an app, can be executed on a mobile end device, such as a smartphone, in order to allow a user to interact with the server and thus with the vehicle. This enables a user to request status information from the server about their vehicle by means of the mobile end device and to provide the control commands. This means that a convenience function can be provided, with which the user can conveniently check whether everything is in order with their vehicle.

Such a method is known from DE 10 2018 007 437 A1. The transmission of the status information from the vehicle to the server and thus to the mobile end device of the user is only possible when the telecommunications unit of the vehicle is connected to the internet via mobile radio. If the vehicle drives into a dead zone, for example into a car park, an underground garage or similar, the mobile radio connection can break off, so that the transmission of the status information is not possible anymore. Access to the vehicle status by means of the mobile end device is then no longer possible or false, specifically outdated information is displayed. In order to solve this problem, the method disclosed in the document provides that the vehicle directly transmits the status information to the mobile end device of the user when the mobile radio connection breaks off, which mobile end device in turn is used to pass the status information on to the server. The mobile end device therefore functions as temporary data storage and a communication relay. However, the mobile end device and the telecommunications unit can simultaneously lose their mobile radio connection.

However, if the user leaves the dead zone by foot, for example by leaving an underground garage, the mobile connection of the mobile end device to the internet can be restored quickly, which enables data transmission of the cached status information of the vehicle to the server, although the vehicle itself is still located in the dead zone. However, while it is in the dead zone, the status of the vehicle can change again, which cannot be identified by means of the method disclosed in the document.

A further method and a system for providing vehicle data is also known, for example, from EP 3 128 721 A1. The method provides for monitoring a mobile radio signal strength of a motor vehicle and, when an interrupted mobile radio connection is identified, checking whether the vehicle is parked in the case of an interrupted mobile radio connection. If this is the case, the position at which the vehicle is parked is stored and classified as a dead point. If the vehicle again approaches this dead point to within a specified distance on a later journey, the vehicle transmits vehicle data to a server device. In particular, this data includes the position of the vehicle at which the vehicle has approached the dead point to within a specified distance and, where appropriate, further data such as the fuel level, the battery charging state, and similar.

Exemplary embodiments of the present invention are directed to further improving a method for determining at least one status of a vehicle.

A generic method for determining at least one status of a vehicle, wherein the vehicle determines the status and transmits this by means of a vehicle-internal telecommunications unit in the case of an existing wireless communication link to a vehicle-external central computing unit and transmits the status to a mobile end device communicatively coupled to the vehicle in the case of an interrupted communication link, the mobile end device temporarily caches the status received from the vehicle and passes it on to the central computing unit in the case of an available wireless communication link between the mobile end device and the central computing unit, is further developed according to the invention in that the vehicle only determines the status in the case of an interrupted communication link to the central computing unit when the doors of the vehicle are locked and then transmits the status to the mobile end device. With the aid of the method according to the invention, status changes that take place even after the communication link between the vehicle or telecommunications unit and central computing unit breaks off can be detected and their influence on the status of the vehicle can be taken into consideration.

For example, the communication link between the vehicle and the central computing unit can be interrupted when driving the vehicle into an underground garage. Here, the vehicle transmits the information as a status that the doors of the vehicle are unlocked and the driver's window is lowered. This corresponds to the status when driving into the underground garage, in which the person driving the vehicle takes a parking ticket from a machine. The vehicle then drives on into the underground garage and is parked in a parking space. The driver's window is closed and the doors of the vehicle are locked when the person driving the vehicle leaves the vehicle. If the status of the vehicle were to be directly transmitted to the mobile end device when the communication link is interrupted, which mobile end device later transmits this information to the central computing unit, a status not matching reality would be stored on the central computing unit, specifically “unlocked doors” and “lowered window”.

However, by only transmitting the status to the mobile end device when the doors of the vehicle are locked, the actual status of the vehicle is detected more reliably. For instance, the point in time at which the vehicle is locked usually corresponds to the time at which the person driving the vehicle leaves their vehicle. From this point in time onwards, no other changes of the status should take place. Thus, the actual status of the vehicle is cached in the mobile end device in a more reliable way, and this is then transmitted to the central computing unit with renewal of the communication link. Thus, it can be prevented that a warning message is displayed on the mobile end device to the person driving the vehicle, for example when they leave the underground garage, that the driver's window is still lowered and the vehicle doors are unlocked.

Different characteristics of the vehicle or of vehicle components can be considered as a status of the vehicle. These include the door locking status, the degree of opening of the window of the vehicle, the tank capacity, the charging state of a traction battery, whether the headlights of the vehicle are on, whether the infotainment system of the vehicle is on, in particular which audio source is configured and whether and which media is being played back, whether the parking light is on, what tire pressure has been measured last, whether a mobile end device is coupled to the vehicle, and similar. The status of the vehicle can thus describe the state of one or more vehicle subsystems, vehicle components, and similar.

The wireless communication link between the telecommunications unit and central computing unit can, as described above, be considered to be an internet connection of the telecommunications unit to the central computing unit via mobile radio. It is also conceivable that the telecommunications unit is additionally or alternatively connected to the internet via WiFi, for example via a stationary WiFi hotspot. Such hotspots can be installed, for example, in public car parks or also in the private garage of the person driving the vehicle, and the communication link of the vehicle to the central computing unit can be maintained when the mobile radio connection is interrupted. In contrast, if a WLAN connection is not possible, then the method according to the invention becomes useful.

The vehicle determines the status constantly, for example after a specified interval. Accordingly, status updates are transmitted to the central computing unit, in order to update the status of the vehicle held on the central computing unit to the actual status, i.e., to update it.

The mobile end device may be any device, such as a tablet computer, smartphone, laptop, wearable or similar. However, the mobile end device itself has to be able to send the status received from the vehicle to the central computing unit via a wireless communication link. Thus, smartphones in particular are suitable for performing the method because of the mobile connection that can expediently be provided.

The method according to the invention is not restricted to the driving in and parking of the vehicle in car parks, underground garages, and similar. For instance, the communication link between the telecommunications unit and the central computing unit can break off in any dead zone, for example in a remote region with poor mobile network. For example, the person driving the vehicle can also park their vehicle in a parking space in a dead zone and go for a hike. Then, for example, the person driving the vehicle can climb a hill or mountain, on which the carried mobile end device can get reception again. Thus, in such a situation, the status of the vehicle can be reliably transmitted to the central computing unit.

An advantageous development of the method provides that third parties request the status of the vehicle from the central computing unit. The central computing unit is set up to offer third-party access to the information managed by the central computing unit. As the status of the vehicle is transmitted to the mobile end device of the person driving the vehicle anyway when the vehicle doors are locked, the current status information is available already in the mobile end device. The method according to the invention, however, becomes particularly useful when third parties would also like to see the status of the vehicle, such as family members of the person driving the vehicle or a service provider. The vehicle may be a fleet vehicle and the third party may be the manager of the vehicle fleet. Thus, third parties are also able to reliably read out the current status of the vehicle. “Third parties” also includes the vehicle owner or the person driving the vehicle themselves.

A further advantageous embodiment of the method according to the invention further provides that when the central computing unit determines the interruption of the communication link to the telecommunications unit, the central computing unit integrates a status indication into the status of the vehicle held on the central computing unit, which status indication describes that the held status may be flawed. This means that it is more reliably prevented that a party interested in the status of the vehicle falsely interprets the status of the vehicle or believes a false status.

So that the status of the vehicle transmitted to the mobile end device can be transmitted to the central computing unit, similarly the mobile end device again requires a communication link to the central computing unit, i.e., for example, via a re-initiated mobile radio connection. However, if the person driving the vehicle stops for a relatively long time in the dead zone, the mobile end device cannot transmit the status of the vehicle to the central computing unit. If in this time third parties intercept the status of the vehicle from the central computing unit, they read out the last transmitted status, which however does not then necessarily correspond to the current actual status anymore. The central computing unit can however provide a corresponding status indication in this case, which informs the third parties that current status information can no longer be received from the vehicle due to the interrupted communication link, thus the held and presented status may be faulty (outdated).

Once the central computing unit can receive a status from the mobile end device again, then according to a preferred embodiment of the method according to the invention, this status indication is deleted. Therefore, the status can be sent both from the vehicle-internal telecommunications unit as well as from the mobile end device.

A further advantageous embodiment of the method according to the invention further provides that the vehicle transmits the status as a data packet to the mobile end device and the mobile end device checks the data packet for completeness. The data packet can, for example, have a set data structure for this purpose. For example, the respective status can be included in the data packet for a predefined number of characteristics of the vehicle for each data transmission. During the transmission of the data packet, the communication link between a mobile end device and vehicle can also break off, meaning that only parts of the data packet can be transmitted. The mobile end device can then check the data packet for completeness, in order to determine such a case. For this purpose, the mobile end device checks whether all of the information corresponding to the set data structure is contained in the data packet. The mobile end device can be linked to the vehicle in a proven way, for example via Bluetooth, WiFi, ZigBee, NFC, or similar. In particular, if the data packet is particularly large in relation to the memory size, and the person driving the vehicle moves away from the vehicle comparatively quickly after closing the vehicle, there is an increased danger that not all relevant information concerning the status can be transmitted.

The mobile end device and the vehicle can also be in bidirectional communication, meaning that the vehicle sends corresponding information to the mobile end device when the data packet has been sent completely. The mobile end device can then transmit back to the vehicle that this information has been received. Only when the vehicle and the mobile end device have confirmed to each other that the data packet has been sent completely and has been received completely does the mobile end device output the information that the data packet is complete.

Particularly preferably, the data packet comprises an information part and a useful part, wherein the useful part contains the status and the information part describes a scope of the useful part. The data packet can also be understood as a digital message composed of a header and a payload. The header describes the size of the data packet and, if necessary, further parameters, such as the time at which the data transmission was started, which status information is contained in the useful part as status, i.e., for example, whether there is only a status update for the door locking and the low beam or for further components of the vehicle, and similar. The information describing the respective status then forms the useful part. This has the advantage that the data packet can have a flexible data structure.

In this case, status information can be included in the data packet in the manner of a difference update. In other words, status changes are included in the data packet only for such characteristics of the vehicle in the case of which a status change has been determined between the last transmission. Thus, the memory size of the data packet can be reduced.

A further advantageous embodiment of the method according to the invention further provides that the mobile end device outputs a warning indication when the mobile end device determines the data packet has been transmitted incompletely. This means that the person driving the vehicle can be prompted to ensure successful data transmission. For example, should the data transmission be unsuccessful because the person driving the vehicle has moved away from the vehicle too early and too quickly, the person driving the vehicle can go back with the mobile end device into the radio range of the vehicle. This means that it can be ensured that the status of the vehicle is transmitted more reliably to the mobile end device and accordingly passed on to the central computing unit. Optical, acoustic, and haptic information can be output by the mobile end device as a warning indication. For example, a warning tone sounds and the mobile end device vibrates when the person driving the vehicle moves away from the vehicle after closing the latter and the data transmission of the status to the mobile end device is incomplete. Thus, the person driving the vehicle can identify the warning indication, even when they are carrying the mobile end device in a bag. Consequently, the person driving the vehicle can take the mobile end device in their hand and read a warning message on the display of the mobile end device, which contains a request to complete the data transmission.

According to the invention, in an information technology system, comprising a vehicle, a central computing unit and a mobile end device, the vehicle, the central computing unit and the mobile end device are set up to perform a method described above. The vehicle may be any road vehicle such as a car, lorry, van, bus, or similar. The vehicle may also be a railway vehicle, water vessel, or aircraft. To determine that the vehicle has been parked, the door locking status is monitored. Accordingly, the vehicle has doors that can be locked. Locking the doors is possible, for example, by means of a radio key or also by means of a mobile end device. The mobile end device and the vehicle can be set up accordingly for this purpose. Such a function is also referred to as “keyless go”.

The central computing device can be a cloud server, for example, also referred to as a backend. The central computing unit is preferably operated by the vehicle manufacturer.

The respective hardware components, i.e., a corresponding vehicle-internal computing unit, such as a central onboard computer, a control device of a vehicle subsystem or also the telecommunications unit itself, and the central computing unit and the mobile end device each execute a computer program product enabling the steps of the method according to the invention that are carried out by the respective hardware components. The respective computer program product is held in a computer-readable storage medium on the respective hardware components. The respective storage media and the respective computer program products are thus similarly part of the invention.

Further advantageous embodiments of the method according to the invention for determining at least one status of a vehicle also result from the exemplary embodiments which are described in more detail below with reference to the figures.

### BRIEF DESCRIPTION OF THE DRAWING FIGURES

Here the figures show:

FIG. 1 a schematic representation of a vehicle driving into an underground garage; and

FIG. 2 a flow chart of a method according to the invention.

### DETAILED DESCRIPTION

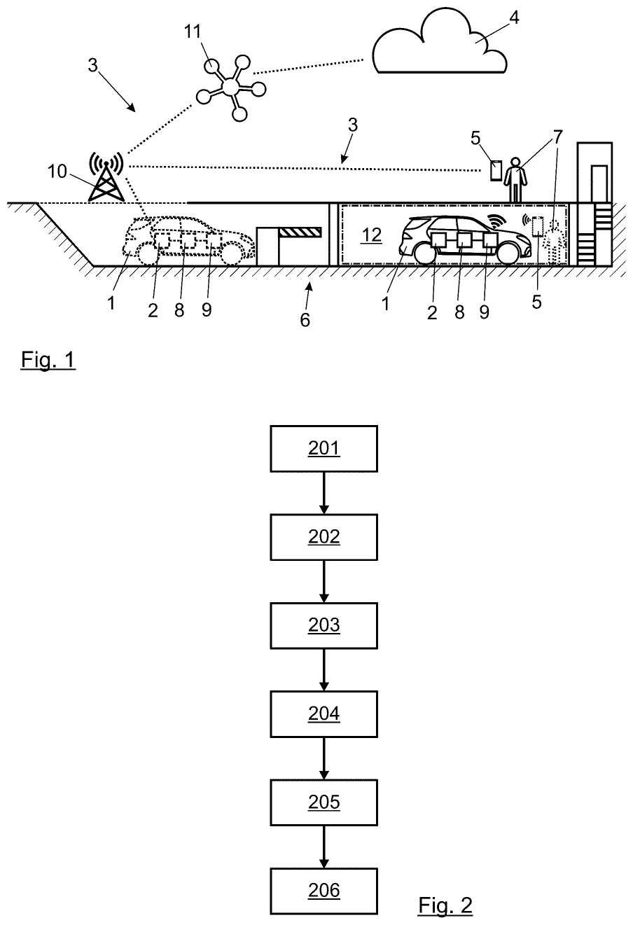

FIG. 1 shows a vehicle 1 that drives into an underground garage 6. The vehicle 1 has a convenience function, by means of which the person 7 driving the vehicle can request a status of the vehicle 1 from outside the vehicle 1 via a carried mobile end device 5. A status of the vehicle 1 can be understood as the characteristic of a vehicle component or of a vehicle subsystem and/or of a vehicle function. This includes, for example, the ignition status, the locking status of the vehicle doors, a degree of opening of a window, which illumination devices of the vehicle 1 are being operated, and similar.

In order to provide this functionality, a vehicle-internal computing unit 8 can read out information from various control devices 9 via a data bus and send it to a central computing unit 4 via a telecommunications unit 2. Typically, the telecommunications unit 2 is connected to a mobile network base station 10 via mobile radio, which in turn enables communication with the central computing unit 4 via the internet 11. This means that a wireless communication link 3 is provided.

The mobile end device 5 is similarly connected to the central computing unit 4 by a wireless communication link 3 by mobile radio via the internet 11 and thus can intercept the data related to the vehicle 1.

If the vehicle 1 drives into the underground garage 6, the vehicle 1 encounters a dead zone 12. Status information detected by the vehicle 1 can then no longer be transmitted to the central computing unit 4 via mobile radio. If the person 7 driving the vehicle then stops outside the underground garage 6 and would like to request the status of the vehicle 1, the last transmitted status is requested from the central computing unit 4, which then describes, for example, that the doors of the vehicle 1 are unlocked and the driver's window is lowered, as this corresponds to the state of the vehicle 1, indicated by the dashed line, when driving into the underground garage 6 during which the wireless communication link 3 has been interrupted.

With the aid of a method according to the invention, it can now be prevented that such false status messages are displayed to the person 7 driving the vehicle, which could unsettle the person 7 driving the vehicle. For this purpose, it is provided according to the invention that, after it has been parked, the vehicle 1 again checks and determines the status when it receives a locking command and directly transmits the status to the mobile end device 5. The mobile end device 5 serves as temporary storage, as it similarly stops inside the dead zone 12 when the vehicle 1 has been left, and thus communication between the central computing unit 4 and the mobile end device 5 may similarly not be possible. The person 7 driving the vehicle stands outside the vehicle 1 when locking the vehicle 1, as indicated by a dashed line. Thus, no further status changes are to be expected.

If the person 7 driving the vehicle leaves the underground garage 6, as indicated by a solid line, the mobile end device 5 can again establish a wireless communication link 3 to the central computing unit 4 and can transmit the status information thus received by the vehicle 1 and temporarily cached to the central computing unit 4. Thus, it is ensured that the actual status of the vehicle 1 is also held in the central computing unit 4.

FIG. 2 indicates the process by means of a flow chart. In a method step 201, the vehicle 1 continuously determines the status.

In a method step 202, the telecommunications unit 2 establishes that the wireless communication link 3 to the central computing unit 4 has been broken.

In a method step 203, the vehicle 1 then monitors a door locking status. This can be carried out by one of the hardware components shown, i.e., for example, by the telecommunications unit 2, the vehicle-internal computing unit 8 or any control device 9. If the vehicle 1 then receives a door locking command, the status of the vehicle is detected again and is transmitted to the mobile end device 5 in the method step 204.

In a method step 205, the mobile end device 5 checks whether a wireless communication link 3 can be established with the central computing unit 4.

If this is the case in the method step 206, the mobile end device 5 conveys the status obtained from the vehicle 1 to the central computing unit 4. There, the status can be provided again accordingly to third parties or also to the person 7 driving the vehicle via the mobile end device 5.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-8. (canceled)

9. A method comprising:
determining, by a vehicle, at least one status of the vehicle;
determining, by the vehicle, that an existing wireless communication link between a vehicle-internal telecommunications unit and a vehicle-external central computing unit is interrupted;
transmitting, by the vehicle to a mobile end device communicatively coupled to the vehicle and when it is determined that the existing wireless communication link is interrupted, the determined at least one status of the vehicle;
temporarily caching, by the mobile end device, the at least one status of the vehicle received from the vehicle;
determining, by the mobile end device that a wireless communication link is available between the mobile end device and the vehicle-external central computing unit; and
transmitting, by the mobile end device to the vehicle-external central computing unit based on the determination that the wireless communication link between the mobile end device and the vehicle-external central computing unit is available, the at least one status of the vehicle,
wherein, when it is determined that the existing wireless communication link between the vehicle-internal telecommunications unit and the vehicle-external central computing unit is interrupted, the vehicle only determines the at least one status of the vehicle when doors of the vehicle are locked, and then the vehicle transmits the at least one status of the vehicle to the mobile end device.

10. The method of claim 9, further comprising:
retrieving, by third parties from the central computing unit, the at least one status of the vehicle.

11. The method of claim 9, further comprising:
determining, by the central computing unit, that the existing wireless communication link between a vehicle-internal telecommunications unit and a vehicle-external central computing unit is interrupted; and
integrating, by the central computing unit, a status indication into the at least one status of the vehicle stored on the central computing unit, wherein the status indication describes that the at least one status of the vehicle stored on the central computing unit may be flawed.

12. The method of claim 11, further comprising:
receiving, by the central computing unit subsequent to the central computing unit determining that the existing wireless communication link between a vehicle-internal telecommunications unit and a vehicle-external central computing unit is interrupted, a new at least one status of the vehicle, wherein the new at least one status of the vehicle is received by the central computing unit from the vehicle-internal telecommunications unit of the vehicle or from the mobile end device; and
deleting, by the central computing unit responsive to the central computing receiving the new at least one status of the vehicle.

13. The method of claim 9, wherein the vehicle transmits the at least one status of the vehicle as a data packet to the mobile end device and the mobile end device checks the data packet for completeness.

14. The method of claim 13, wherein the data packet comprises an information part and a useful part, wherein the useful part contains the at least one status and the information part describes a scope of the useful part.

15. The method of claim 13, further comprising:
determining, by the mobile end device, that the data packet is incompletely transmitted; and
outputting, by the mobile end device responsive to the determining that the data packet is incompletely transmitted, a warning indication.

16. An information technology system comprising:
a vehicle;
a central computing unit; and
a mobile end device,
wherein the vehicle is configured to determine at least one status of the vehicle,
wherein the vehicle is configured to determine that an existing wireless communication link between a vehicle-internal telecommunications unit and a vehicle-external central computing unit is interrupted,
wherein the vehicle is configured to transmit, to a mobile end device communicatively coupled to the vehicle and when it is determined that the existing wireless communication link is interrupted, the determined at least one status of the vehicle,
wherein the mobile end device is configured to temporarily cache the at least one status of the vehicle received from the vehicle,
wherein the mobile end device is configured to determine that a wireless communication link is available between the mobile end device and the vehicle-external central computing unit,
wherein the mobile end device is configured to transmit, to the vehicle-external central computing unit based on the determination that the wireless communication link between the mobile end device and the vehicle-external central computing unit is available, the at least one status of the vehicle,
wherein, when it is determined that the existing wireless communication link between the vehicle-internal telecommunications unit and the vehicle-external central computing unit is interrupted, the vehicle is configured to only determine the at least one status of the vehicle when doors of the vehicle are locked, and then the vehicle is configured to transmit the at least one status of the vehicle to the mobile end device.
